(19) United States
(12) Patent Application Publication
(10) Pub. No.: US 2025/0310712 A1
(43) Pub. Date: Oct. 2, 2025

(54) DIRECTIVITY MEASUREMENT METHOD AND DEVICE FOR A MULTIPLE SOUND SOURCE MICROPHONE

(71) Applicant: Lanto Electronic Limited, Kunshan City (CN)

(72) Inventors: Han Ting CHIN, Kunshan City (CN); Yu-Hsuan LIN, Kunshan City (CN); Chien Kai TSENG, Kunshan City (CN); Chuan Hsin CHANG, Kunshan City (CN); Sheng Cyuan FAN, Kunshan City (CN)

(21) Appl. No.: 18/823,125

(22) Filed: Sep. 3, 2024

(30) Foreign Application Priority Data
Mar. 27, 2024 (CN) 2024103548488

(51) Int. Cl. H04R 29/00; H04R 1/34

(52) U.S. Cl. CPC H04R 29/004; H04R 1/342; H04R 2430/20

(57) ABSTRACT

A directivity measurement method and device for a multiple sound source microphone is disclosed, wherein a first sound wave generated by a first sound source overlaps and interferes with a second sound wave generated by a second sound source, and a transmission range of the first and second sound waves encompasses a measurement position. Because the first sound wave of the first sound source and the second sound wave of the second sound source overlap and interfere with each other, the intensity of the amplitude of the overlapped and interfered with first and second sound waves, while smoothly varying, is obtained at a position closer to the first sound source and the second sound source. Therefore, the directivity of a microphone to be tested can effectively and accurately be measured even if the microphone to be tested is placed close to the first sound source and the second sound source.

### CROSS-REFERENCES

This application claims the priority benefit of Chinese Patent Application Serial Number 2024103548488, filed on Mar. 27, 2024, the full disclosure of which is incorporated herein by reference.

### TECHNICAL FIELD

This present disclosure relates to a performance measurement method and device for a microphone, and more particularly to a directivity measurement method and device for a multiple sound source microphone.

### DESCRIPTION OF RELATED ART

Air-conduction microphones have different directivities due to differences in design. The signal strength of the received sound signal varies according to the direction, and different types of microphones are suitable for different usage scenarios. Therefore, directivity is a necessary inspection item for producing microphones.

The directional microphone has an opening in front of a diaphragm to allow the acoustic pressure to enter the front of the diaphragm, and there is also an opening at a specific position behind the diaphragm to allow the acoustic pressure to enter the rear of the diaphragm. The static pressure difference caused by the front acoustic pressure and the rear acoustic pressure acting on the diaphragm is the reason why the diaphragm of the directional microphone vibrates.

As shown in FIG. 1, the existing method of measuring the directivity of a microphone is to place the directional microphone M at a position with an appropriate distance relative to a point sound source S. Sound waves are received through a front opening M1 and a rear opening M2 of the diaphragm of the directional microphone. Sound waves have different phases, which result in static pressure differences. Therefore, the directivity of the microphone can be measured. The acoustic wave emitted by the point sound source is a spherical wave. FIG. 2 shows the relationship between the total acoustic pressure and the distance of a single point sound source. FIG. 3 shows the acoustic pressure changes in the front and rear of the directional microphone M when the distances from the single point sound source S are 10 cm and 50 cm respectively. The solid line represents the state where the distance between the directional microphone M and the single point sound source S is 10 cm. The dotted line represents the state where the distance between the directional microphone M and the single point sound source S is 50 cm. As shown in FIG. 3, the change of the amplitude of the acoustic wave at a distance of 10 cm from the point sound source is 0.82 dB, and the change of the amplitude of the acoustic wave at a distance of 50 cm from the point sound source is 0.17 dB. When the measurement position is too close to the point sound source, the amplitude of the acoustic wave will change drastically within a small distance (e.g., within the distance between the front opening and rear opening of the diaphragm of the microphone diaphragm). Therefore, even if the front opening and the rear opening of the directional of the microphone receive acoustic waves with the same phase, a static pressure difference will still occur in the diaphragm of the directional microphone because of the excessive amplitude difference between the acoustic waves received by the front opening and the rear opening. Therefore, the existing method of measuring the directivity of a microphone with a single point sound source requires placement of the microphone far away from the point sound source. With this method, the amplitude of the acoustic wave changes only slightly so as to avoid the problem of inaccurate measurement caused by excessive differences in amplitude. With the existing measurement method, the microphone needs to be at least 50 cm away from a single point sound source. To meet this requirement, a larger test environment must be constructed to effectively and accurately measure the directivity of a microphone. Therefore, existing measurement methods have considerable requirements on the size of the test environment.

### SUMMARY OF THE INVENTION

The embodiment of the present disclosure provides a directivity measurement method and a device for a multiple sound source microphone to solve the problem in the existing technology of the considerable requirements on the size of the test environment.

In order to achieve the above object and other related objects, the present disclosure provides a directivity measurement method of a multiple sound source microphone, which includes the following steps: providing a first sound source; providing a second sound source; disposing a microphone to be tested at a measurement position; turning on the first sound source and the second sound source, wherein a first sound wave generated by the first sound source overlaps and interferes with a second sound wave generated by the second sound source, and a transmission range of the overlapped and interfered with first and second sound waves encompasses the measurement position; measuring an electronic signal of the microphone to be tested at the measurement position to obtain a directivity of the microphone to be tested.

In one embodiment, the measurement position is located on a vertical line passing through a midpoint of a line connecting the first sound source and the second sound source.

In one embodiment, the directivity measurement method further includes rotation of the microphone to be tested, wherein a recording port of the microphone to be tested at the measurement position has a first angle relative to the vertical line.

In one embodiment, the directivity measurement method further includes rotation of the microphone to be tested, wherein the recording port of the microphone to be tested at the measurement position is rotated from the first angle to a second angle relative to the vertical line.

In one embodiment, a distance between the measurement position and the first sound source is greater than 5 cm and a distance between the measurement position and the second sound source is greater than 5 cm.

In one embodiment, a distance between the measurement position and the first sound source is 10 cm and a distance between the measurement position and the second sound source is 10 cm.

In one embodiment, the directivity measurement method further includes the provision of a third sound source, wherein the measurement position is symmetrical to the first sound source, the second sound source and the third sound source.

In one embodiment, the first sound wave and the second sound wave have the same amplitude and frequency.

In order to achieve the above object and other related objects, the present disclosure provides a directivity measurement device for a multiple sound source microphone, which includes a first sound source, a second sound source, a carrier platform and a signal measurement module. The first sound source generates a first sound wave. The second sound source generates a second sound wave. The carrier platform for carrying a microphone to be tested is disposed at a measurement position. The signal measurement module is electrically connected to the microphone to be tested, and the signal measurement module measures an electronic signal of the microphone to be tested at the measurement position for obtaining a directivity of the microphone to be tested. The first sound wave overlaps and interferes with the second sound wave, and a transmission range of the overlapped and interfered with first and second sound waves encompasses the measurement position.

In one embodiment, the measurement position is located on a vertical line passing through a midpoint of a line connecting the first sound source and the second sound source, and the first sound wave and the second sound wave have the same amplitude and frequency.

According to the above, the directivity measurement method and device of the multiple sound source microphone of the present disclosure have the following beneficial effects: Because the first sound wave generated by the first sound source and the second sound wave generated by the second sound source overlap and interfere with each other, the intensities of the amplitudes of the overlapped and interfered with first and second sound waves, while smoothly varying, is obtained at a position closer to the first sound source and the second sound source. Therefore, even if the microphone to be tested is placed close to the first sound source and the second sound source, the directivity of the microphone can be measured effectively and accurately.

### BRIEF DESCRIPTION OF DRAWINGS

FIG. 1 is a schematic of a directivity measurement method of a microphone of a prior art according to the prior art.

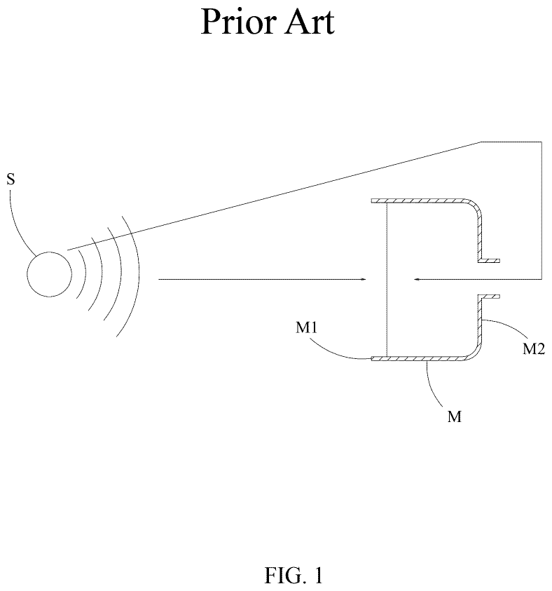

FIG. 2 is a schematic of the relationship between a static pressure and a distance of the sound wave from a single point sound source.

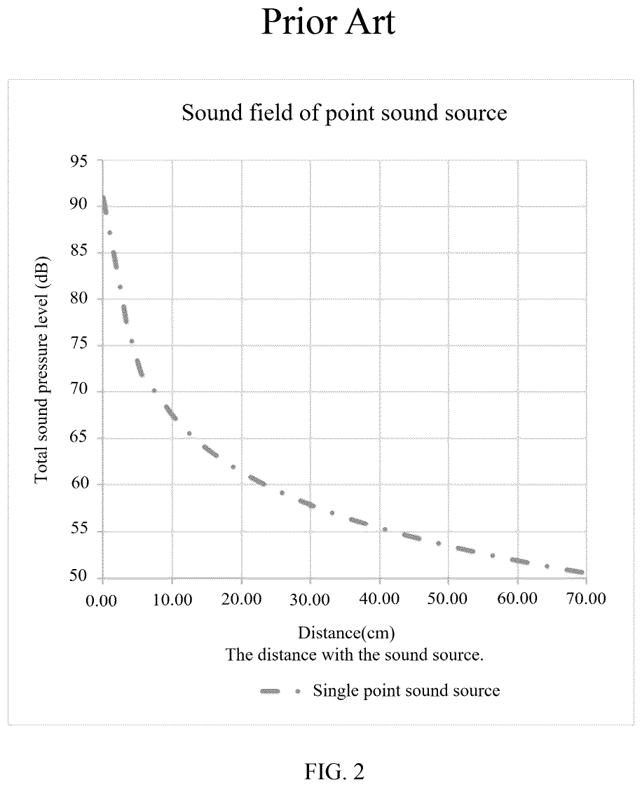

FIG. 3 is a schematic of the changes in the static pressure of the sound wave under the action of the single point sound source when the distances between the front side, the rear side and the single point sound source are different.

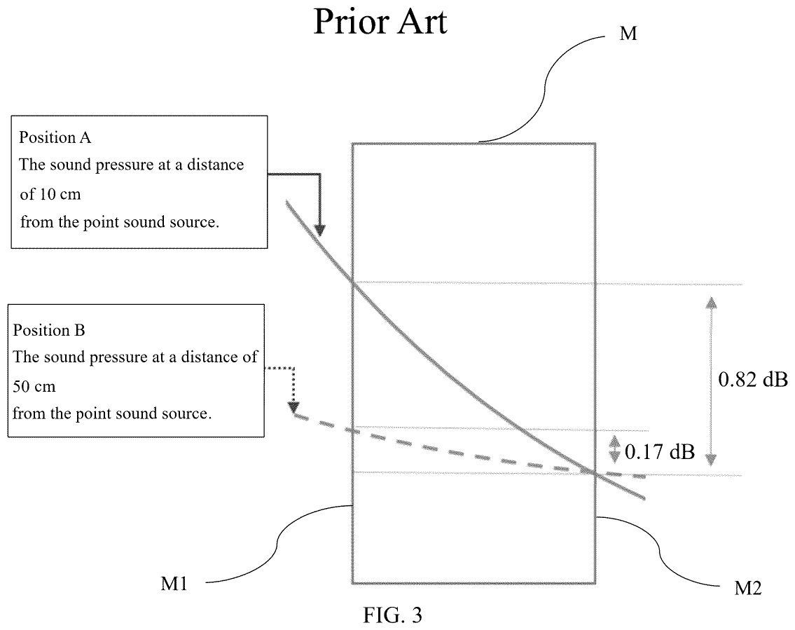

FIG. 4 is a schematic of a directivity measuring device of a multiple sound source microphone according to an embodiment of the present disclosure.

FIG. 5 is a schematic of the relationship between a static pressure and a distance of a sound wave of dual sound sources and a single point sound source.

FIG. 6 is a schematic of the static pressure change of the sound wave under the action of dual sound sources when a front side and rear side of the directional microphone are at different distances from the single point sound source.

FIG. 7 is a schematic of a flow chart of a directivity measurement method of a multiple sound source microphone according to an embodiment of the present disclosure.

### DESCRIPTION OF THE INVENTION

The present invention will be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that the description of this present invention will be thorough and complete and will fully convey the scope of the present invention to those skilled in the art.

For convenience of description, spatial relationship words such as “below”, “lower than”, “under”, “above”, “on”, etc. may be used herein to describe the relationship between one component or feature to other component or feature shown in the drawings. These spatial relationship words encompass directions of the device in use or operation other than those depicted in the figures.

In the present disclosure, unless otherwise expressly stipulated and limited, the terms “installation”, “connection”, “connection”, “fixing” and other terms should be understood in a broad interpretation. For example, it can be a fixed connection, a detachable connection, or one piece; it can be a mechanical connection or an electrical connection; it can be directly connected or indirectly connected through an intermediary; it can be the internal connection between two components or the interaction between two components. Unless otherwise expressly defined, a person ordinary skill in the art can understand the specific meanings of the above terms in this application according to specific circumstances.

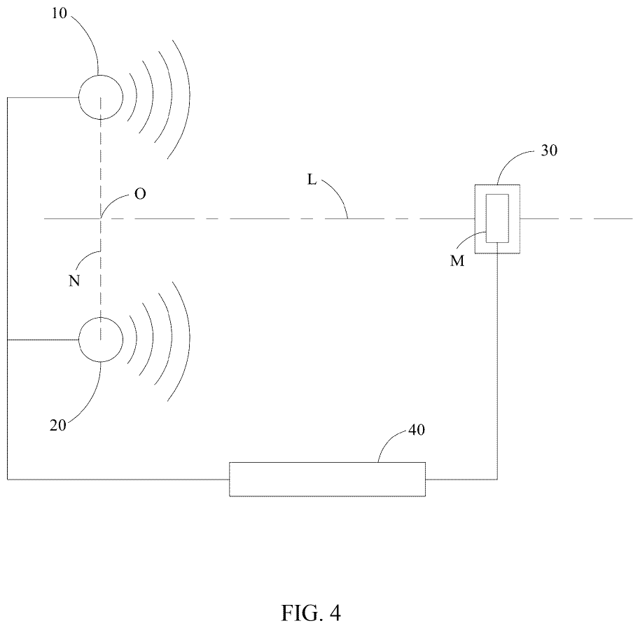

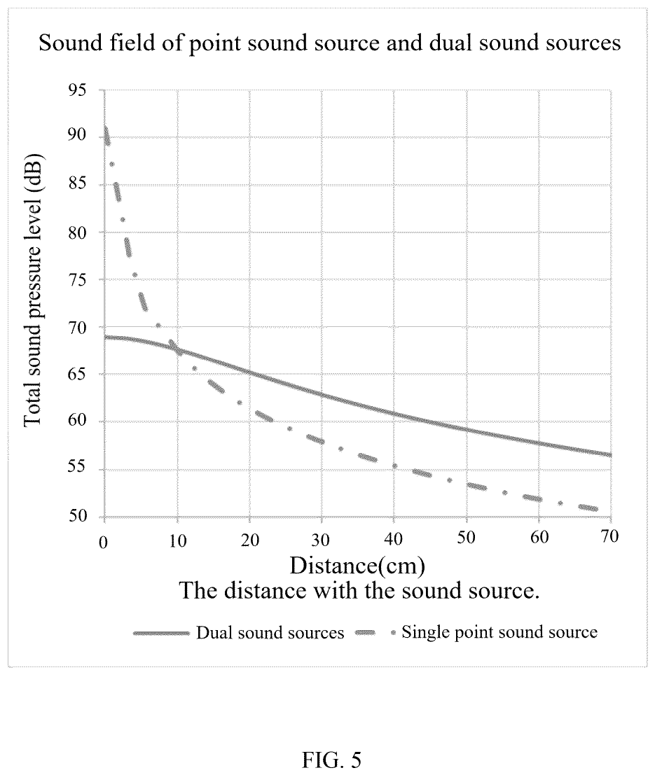

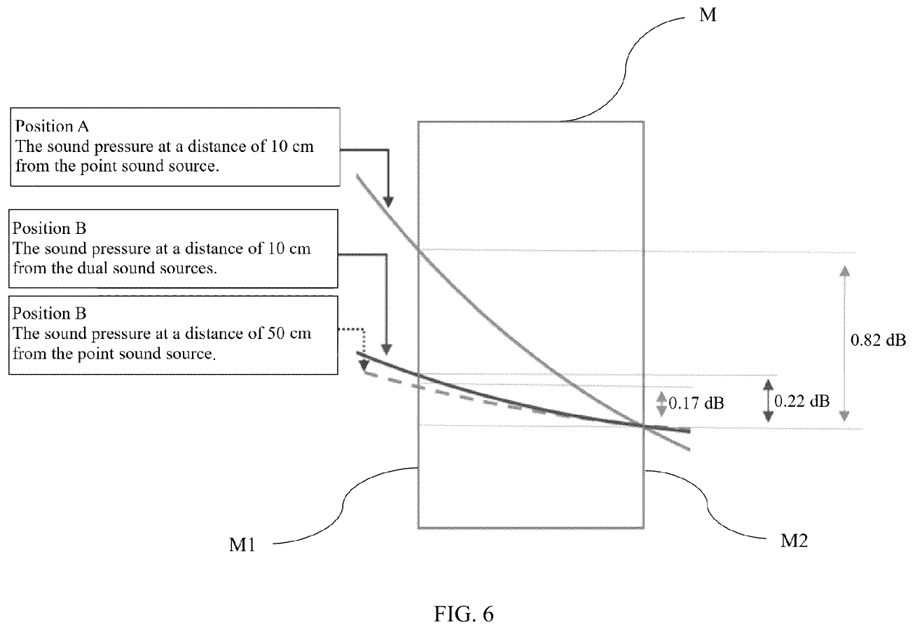

Please refer to FIG. 4, FIG. 5 and FIG. 6. FIG. 4 is a schematic of a directivity measuring device of a multiple sound source microphone according to an embodiment of the present disclosure. FIG. 5 is a schematic of the relationship between a static pressure and a distance of a sound wave of dual sound sources and a single point sound source. FIG. 6 is a schematic of the static pressure change of the sound wave under the action of dual sound sources when a front side and a rear side of the directional microphone are at different distances from the single point sound source. As shown in FIG. 4, the directivity measurement device of the multiple sound source microphone of this embodiment includes a first sound source 10, a second sound source 20, a carrier platform 30 and a signal measurement module 40. The first sound source 10 produces a first sound wave. The second sound source 20 produces a second sound wave. The carrier platform 30 is placed in the measurement position for carrying the microphone M to be tested. An electrical connection is formed by the signal measurement module 40 and the microphone M to be tested. After the microphone M to be tested receives the first sound wave and the second sound wave, it converts the static pressure of the sound waves into a voltage signal or current signal. The signal measurement module 40 obtains the directivity measurement result of the received voltage signal or current signal of the static pressure after calculation and analysis. The first sound wave generated by the first sound source 10 and the second sound wave generated by the second sound source 20 are both spherical waves. After the first sound wave and the second sound wave overlap and interfere in space, the static pressure of the synthesized sound wave is expressed by the following equation:

$$ρ = \frac{A}{{r}_{1}} {e}^{j ( ω t - {kr}_{1} )} + \frac{A}{{r}_{2}} {e}^{j ( ω t - {kr}_{2} )}$$

where P is the static pressure, A is a sound wave amplitude, ω is a sound wave frequency, r1 is the distance from the measurement position to the first sound source 10, and r2 is the distance from the measurement position to the second sound source 20. In the embodiment, the first sound wave generated by the first sound source 10 and the second sound wave generated by the second sound source 20 have the same sound wave amplitude and sound wave frequency.

As shown in FIGS. 5 and 6, an acoustic pressure difference of the directivity measurement device of the multiple sound source microphone of this embodiment at a distance of 10 cm between the measurement position and the first sound source 10 and the second sound source 20 is the acoustic pressure difference of the solid line, and the numerical value of the acoustic pressure difference is 0.22 dB. An acoustic pressure difference of the directivity measurement device of the single point sound source at a distance of 50 cm between the measurement position and the single point sound source is the acoustic pressure difference of the dotted line, and the numerical value of the acoustic pressure difference is 0.17 dB. The acoustic pressure difference between the two is relatively close and is significantly smaller than the acoustic pressure difference of 0.82 dB in the measurement device with a single point sound source (dotted line), where the distance between the measurement position and the single point sound source is 10 cm. As described above, the directivity measurement device of the multiple sound source microphone of this embodiment can shorten the measurement position from the existing 50 cm to 10 cm by providing the first sound source 10 and the second sound source 20. Thus, measurement of the directivity of a microphone in a short distance environment is implemented. The measurement position in this embodiment can be further reduced to a distance greater than 5 cm from the first sound source and a distance greater than 5 cm from the second sound source. The distance between the measurement position and the first sound source can be further reduced to a distance greater than 5 cm, and the distance between the measurement position and the second sound source can be further reduced to a distance greater than 5 cm.

As shown in FIG. 4, the measurement position of the microphone M to be tested in this embodiment is located on a vertical line L passing through a midpoint O of a line N connecting the first sound source 10 and the second sound source 20. Therefore, r1=r2=r, and the above equation simplifies to:

$$ρ = \frac{2 A}{r} {e}^{j ( ω t - kr )}$$

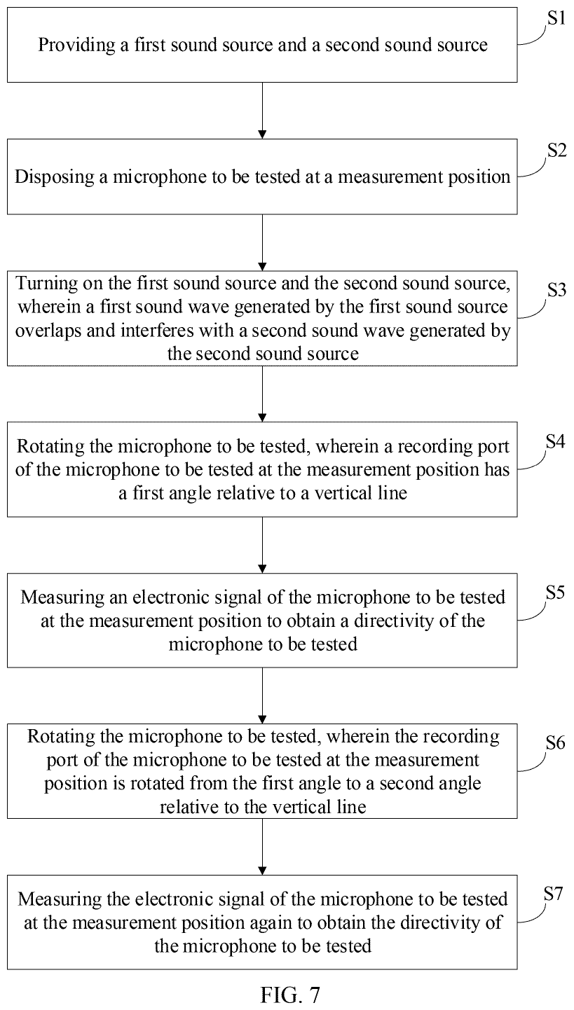

Please refer to FIG. 4 and FIG. 7. FIG. 7 is a schematic of a flow chart of a directivity measurement method of a multiple sound source microphone according to an embodiment of the present disclosure. As shown in the figure, in step S1, a first sound source 10 and a second sound source 20 are provided, and then the process continues to step S2.

In step S2, the microphone to be tested is placed in the measurement position. In the embodiment, the measurement position is on the vertical line L of the midpoint O of the line N connecting the first sound source 10 and the second sound source 20. Then the process continues to step S3.

In step S3, the first sound source 10 and the second sound source 20 are turned on. The first sound wave generated by the first sound source 10 overlaps and interferes with the second sound wave generated by the second sound source 20. The transmission range of the overlapped and interfered with first sound wave and second sound wave encompasses the measurement position. Then the process continues to step S4.

In step S4, the microphone to be tested is rotated. A recording port of the microphone to be tested has a first angle relative to the vertical line L at the measurement position. Then the process continues to step S5.

In step S5, an electronic signal of the microphone to be tested is measured at the measurement position to obtain the directivity of the microphone to be tested. Then the process continues to step S6.

In step S6, the microphone to be tested is rotated. The recording port of the microphone to be tested is rotated from the first angle to a second angle relative to the vertical line L. Then the process continues to step S7.

In step S7, the electronic signal of the microphone to be tested is measured again at the measurement position to obtain the directivity of the microphone to be tested.

In another embodiment, a third sound source is provided. The microphone to be tested receives the sound waves of the first sound source, the second sound source and the third sound source at the measurement position to measure the directivity of the microphone to be tested. It is necessary to control the sound volume and sound phase of each sound source, which is generally achieved using digital control. The measurement position of the microphone to be tested is symmetrical with the first sound source, second sound source and third sound source.

According to the above, because the first sound wave generated by the first sound source and the second sound wave generated by the second sound source overlap and interfere with each other, the intensity of the amplitude of the overlapped and interfered with first and second sound waves, while smoothly varying, is obtained at a position closer to the first sound source and the second sound source. In this way, the directivity of the microphone to be tested can be measured effectively and accurately even if it is placed close to the first sound source and the second sound source.

Although the present disclosure has been explained in relation to its preferred embodiment, the description is not intended to limit the present disclosure. It will be apparent to those skilled in the art with regard to the present disclosure that other modifications of the exemplary embodiments beyond those embodiments specifically described herein may be made without departing from the spirit of the disclosure. Accordingly, such modifications are considered within the scope of the disclosure as limited solely by the appended claims.

1. A directivity measurement method for a multiple sound source microphone comprising:
providing a first sound source;
providing a second sound source;
disposing a microphone to be tested at a measurement position;
turning on the first sound source and the second sound source, wherein a first sound wave generated by the first sound source overlaps and interferes with a second sound wave generated by the second sound source, and a transmission range of the overlapped and interfered with first and second sound waves encompasses the measurement position;
measuring an electronic signal of the microphone to be tested at the measurement position to obtain a directivity of the microphone to be tested.

2. The directivity measurement method for the multiple sound source microphone claimed in claim 1, wherein the measurement position is located on a vertical line passing through a midpoint of a line connecting the first sound source and the second sound source.

3. The directivity measurement method for a multiple sound source microphone claimed in claim 2, further comprising:
rotating the microphone to be tested, wherein a recording port of the microphone to be tested at the measurement position has a first angle relative to the vertical line.

4. The directivity measurement method for a multiple sound source microphone claimed in claim 3, further comprising:
rotating the microphone to be tested, wherein the recording port of the microphone to be tested at the measurement position is rotated from the first angle to a second angle relative to the vertical line.

5. The directivity measurement method for a multiple sound source microphone claimed in claim 1, wherein a distance between the measurement position and the first sound source is greater than 5 cm and a distance between the measurement position and the second sound source is greater than 5 cm.

6. The directivity measurement method for a multiple sound source microphone claimed in claim 1, wherein a distance between the measurement position and the first sound source is 10 cm and a distance between the measurement position and the second sound source is 10 cm.

7. The directivity measurement method for a multiple sound source microphone claimed in claim 1, further comprising:
providing a third sound source, wherein the measurement position is symmetrical to the first sound source, the second sound source and the third sound source.

8. The directivity measurement method for a multiple sound source microphone claimed in claim 1, wherein the first sound wave and the second sound wave have the same amplitude and frequency.

9. A directivity measurement device for a multiple sound source microphone, comprising:
a first sound source for generating a first sound wave;
a second sound source for generating a second sound wave;
a carrier platform disposed at a measurement position, wherein the carrier platform is used for carrying a microphone to be tested;
a signal measurement module electrically connected to the microphone to be tested, wherein the signal measurement module measures an electronic signal of the microphone to be tested at the measurement position for obtaining a directivity of the microphone to be tested;
wherein the first sound wave overlaps and interferes with the second sound wave, and a transmission range of the overlapped and interfered with first and second sound waves encompasses the measurement position.

10. The directivity measurement device for a multiple sound source microphone claimed in claim 9, wherein the measurement position is located on a vertical line passing through a midpoint of a line connecting the first sound source and the second sound source, and the first sound wave and the second sound wave have the same amplitude and frequency.
